(19) United States
(12) Patent Application Publication
(10) Pub. No.: US 2019/0230312 A1
(43) Pub. Date: Jul. 25, 2019

(54) DISPLAY APPARATUS AND CONTROL METHOD THEREOF

(71) Applicant: SAMSUNG ELECTRONICS CO., LTD., Suwon-si, Gyeonggi-do (KR)

(72) Inventors: Hyun-jong SHIN, Suwon-si, Gyeonggi-do (KR); Jun-seok KANG, Incheon (KR); Byung-ju KWAK, Suwon-si, Gyeonggi-do (KR); Chang-hyo KIM, Seoul (KR); Kyoung-seok NOH, Suwon-si, Gyeonggi-do (KR); Dong-jin PARK, Yongin-si, Gyeonggi-do (KR); Young-jin LEE, Suwon-si, Gyeonggi-do (KR)

(21) Appl. No.: 16/339,123

(22) PCT Filed: Aug. 22, 2017
(86) PCT No.: PCT/KR2017/009109

§ 371 Date: Apr. 3, 2019

(30) Foreign Application Priority Data
Oct. 27, 2016 (KR) 10-2016-0141059

(51) Int. Cl. H04N 5/50; H04N 5/44; H04N 21/438

(52) U.S. Cl. CPC H04N 5/50; H04N 2005/4408; H04N 21/4384; H04N 5/4403

(57) ABSTRACT

Disclosed is a display apparatus comprising a signal receiver for receiving a broadcasting signal from at least one broadcasting transmitting apparatus through an antenna; a display for displaying an image thereon based on the transmitted broadcasting signal; a user input unit for receiving a user input; and a controller for performing at least one setting operation based on the user input, and for performing at least one second setting operation relating to a selection of a channel for the broadcasting signal through the signal receiver in parallel with the performance of the first setting operation. Accordingly, a channel setting time of a television may be reduced.

### TECHNICAL FIELD

The disclosure relates to a display apparatus and a control method thereof, and more particularly, to a display apparatus and a control method thereof for performing a setting operation to select a channel.

### BACKGROUND ART

To select a channel in a conventional television, a user firstly performs a channel setting process at an initial setting phase (out of box; OOB) after purchasing a television. In such case, a user selects an automatic channel setting, or sets an input broadcasting method, radio frequency, bandwidth, Symbolrate, QAM, color system, sound system and other information for each of terrestrial, cable and satellite modes to set a channel. Ordinary users are not familiar with such information regarding the channel setting, and thus may feel inconvenient in performing the channel setting process.

If a user otherwise selects the automatic channel setting, he/she should wait and see the whole channel setting process for each of the terrestrial, cable and satellite modes, and spend much time to set channels.

### DISCLOSURE

### Technical Problem

An aspect of the disclosure is to provide a display apparatus and a control method thereof for reducing a time for setting a channel in a television.

Another aspect of the disclosure is to provide a display apparatus and a control method thereof for minimizing a setting of a channel by a user in a television.

### Technical Solution

The foregoing object of the disclosure is achieved by providing a display apparatus comprising a signal receiver for receiving a broadcasting signal from at least one broadcasting transmitting apparatus through an antenna; a display for displaying an image thereon based on the transmitted broadcasting signal; a user input unit for receiving a user input; and a controller for performing at least one setting operation based on the user input, and for performing at least one second setting operation relating to a selection of a channel for the broadcasting signal through the signal receiver in parallel with the performance of the first setting operation.

According to the embodiment of the disclosure as above, the channel setting time of a TV may be reduced. Also, the channel setting by a user may be minimized.

The controller may perform the second setting operation based on at least one of a connection or non-connection of the antenna and a signal strength of the broadcasting signal per channel. Accordingly, the channel setting may be automatically performed by detecting an antenna or a signal strength of a broadcasting signal without a user input.

The controller may perform the second setting operation if it is detected that the antenna is connected. Accordingly, the channel setting may be automatically performed if it is detected that the antenna is connected when the TV is initially set.

The controller may scan the transmitted broadcasting signal per channel, select a channel of which the signal strength of the scanned broadcasting signal is of a predetermined level or higher, and perform the second setting operation with respect to the selected channel. Since the channel setting is performed only with respect to the channel of which the signal strength of a broadcasting is detected to be at a predetermined level or higher, the channel setting time may be reduced.

The display apparatus may further comprise a user input unit to receive a user input. The controller may perform the second setting operation based on the user input. Accordingly, the channel setting may be performed by a user input while the TV is initially set.

The second setting operation may comprise an operation of selecting one of the at least one broadcasting transmitting apparatus based on the user input to select a channel for the broadcasting signal. Accordingly, the channel setting may be performed through a selection by a user of a terrestrial wave, cable or satellite mode under which a broadcasting signal is input while the TV is initially set.

The first setting operation may comprise at least one of a language setting, network setting, consent to terms and conditions, region setting, time setting, device connection and account registration for an initial setting of the display apparatus. Accordingly, while various setting operations are performed to initially set the TV, the channel setting may be performed in parallel.

The controller may display a plurality of menu items on the display regarding a plurality of setting operations, and perform the at least one first setting operation based on a user input with respect to the plurality of menu items. Accordingly, various setting phases may be displayed on a screen to initially set the TV and each setting phase may be performed by a user input.

Also, the foregoing object of the disclosure is achieved by providing a control method of a display apparatus comprising receiving a broadcasting signal from at least one broadcasting transmitting apparatus through an antenna; performing at least one first setting operation based on a user input; and performing at least one second setting operation relating to a selection of a channel for the broadcasting signal in parallel with the performance of the first setting operation.

According to the embodiment of the disclosure as above, the channel setting time of a TV may be reduced. Also, the channel setting by a user may be minimized.

The step of processing the second setting operation in parallel may comprise performing the second setting operation based on whether the antenna is connected and a signal strength of the broadcasting signal per channel. Accordingly, the channel setting may be automatically performed by detecting an antenna or a signal strength of a broadcasting signal without a user input.

The step of performing the second setting operation in parallel may comprise performing the second setting operation if it is detected that the antenna is connected. Accordingly, the channel setting may be automatically performed if it is detected that the antenna is connected when the TV is initially set.

The step of processing the second setting operation in parallel may comprise scanning the transmitted broadcasting signal per channel, selecting a channel of which a signal strength of the scanned broadcasting signal is of a predetermined level of higher, and performing the second setting operation with respect to the selected channel. Since the channel setting is performed only with respect to the channel of which the signal strength of a broadcasting is detected to be at a predetermined level or higher, the channel setting time may be reduced.

The step of performing the second setting operation in parallel may comprise performing the second setting operation based on a user input. Accordingly, the channel setting may be performed by a user input while the TV is initially set.

The second setting operation may comprise an operation of selecting one of the at least one broadcasting transmitting apparatus based on the user input to select the channel for the broadcasting signal. Accordingly, the channel setting may be performed through a selection by a user of a terrestrial wave, cable or satellite mode under which a broadcasting signal is input while the TV is initially set.

The first setting operation may comprise at least one of a language setting, a network setting, a consent to terms and conditions, a region setting, a time setting, a device connection and an account registration for initially setting the display apparatus. Accordingly, while various setting operations are performed to initially set the TV, the channel setting may be performed in parallel.

The control method may comprise displaying a plurality of menu items regarding a plurality of setting operations; and performing the at least one first setting operation based on a user input with respect to the plurality of menu items. Accordingly, various setting phases may be displayed on a screen to initially set the TV and each setting phase may be performed by a user input.

### Advantageous Effects

As described above, according to the disclosure, there is an effect of reducing a time for setting a channel in a television.

Also, according to the disclosure, there is an effect of minimizing a setting of a channel by a user in a television.

### DESCRIPTION OF DRAWINGS

FIG. 1 is a block diagram of a display apparatus according to an embodiment of the disclosure.

FIG. 2 illustrates an example of performing a plurality of setting operations for an initial setting in a related art of the disclosure.

FIG. 3 illustrates an example of a second setting operation that is performed for selecting a channel in parallel with a performance of at least one first setting operation for an initial setting according to an embodiment of the disclosure.

FIG. 4 is a flowchart showing a process for performing a second setting operation according to an embodiment of the disclosure.

FIG. 5 is a flowchart showing processes for performing first and second setting operations according to an embodiment of the disclosure.

FIG. 6 is a flowchart showing a control method of a display apparatus according to an embodiment of the disclosure.

FIG. 7 is a flowchart showing a control method of a display apparatus according to an embodiment of the disclosure.

### BEST MODE

Below, embodiments of the disclosure will be described in detail with reference to accompanying drawings. In the following descriptions of the embodiments, the matters illustrated in the accompanying drawings will be referred. Further, in the embodiments, the components having the direct relation and the concept of the disclosure only will be described, and the description about remaining components except for this will be omitted. However, it will be understood that such omitted components are not unnecessary in terms of realizing an apparatus or system to which the concept of the disclosure is applied. In the following embodiments, it will be understood that terms ‘include’ or ‘have’ are to specify the presence of features, numbers, steps, operations, elements, components or combination thereof described in the disclosure without precluding the presence or addition of one or more other features, numbers, steps, operations, elements, components or combination thereof.

Further, the embodiments described with reference to the accompanying drawings are not exclusive to each other unless otherwise mentioned, and a plurality of embodiments may be selectively combined within one apparatus. The combination of these embodiments may be discretionally selected and applied to realize the present inventive concept by a person having an ordinary skill in the art.

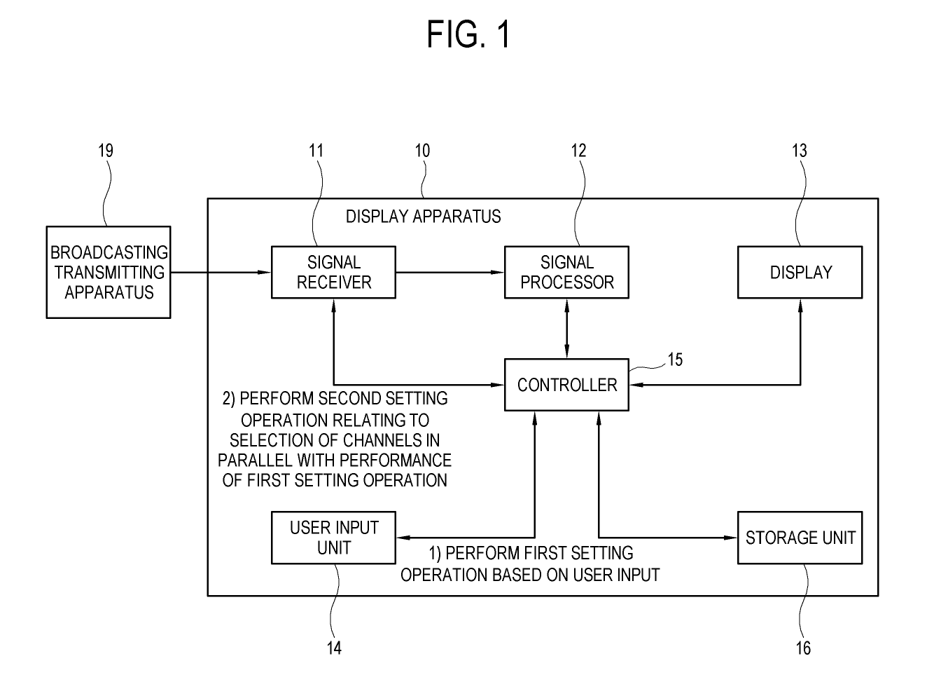

Hereinafter, elements and major embodiments of a display apparatus 10 according to the disclosure will be described with reference to FIGS. 1 to 5. FIG. 1 is a block diagram of a display apparatus 10 according to an embodiment of the disclosure. As shown therein, the display apparatus 10 according to an embodiment of the disclosure may include a signal receiver 11, a signal processor 12, a display 13, a user input unit 14, a controller 15 and a storage unit 16 and may be achieved by, e.g., a TV, smart phone, tablet PC, computer, etc. The display apparatus 10 according to the disclosure may be connected to at least one broadcasting transmitting apparatus 19, and receives a broadcasting signal from the at least one broadcasting transmitting apparatus 19 connected to the display apparatus 10. The elements comprised in the display apparatus 10 according to the disclosure is not limited to the foregoing embodiment, and may exclude a part of the elements or may include additional elements.

The display apparatus 10 according to the disclosure receives a broadcasting signal from at least one broadcasting transmitting apparatus 19 through an antenna. The display apparatus 10 performs at least one first setting operation out of a plurality of setting operations based on a user input transmitted through the user input unit 14. The display apparatus 10 performs at least one second setting operation in relation to a selection of a channel of a broadcasting signal in parallel with a performance of at least one first setting operation.

The signal receiver 11 receives a broadcasting signal from at least one broadcasting transmitting apparatus 19 through an antenna. The signal receiver 11 may vary depending on a specification of a broadcasting signal received by the signal receiver 11 and on an embodiment type of the display apparatus 10. For example, the signal receiver 11 may be achieved by a tuner to receive a radio frequency (RF) broadcasting signal transmitted by a broadcasting station or a satellite signal.

The signal processor 12 performs a preset signal processing operation to a broadcasting signal received by the signal receiver 11. The signal processing operation performed by the signal processor 12 includes, e.g., de-multiplexing, decoding, de-interlacing, scaling, noise reduction and detail enhancement, but not limited thereto. The signal processor 12 may be achieved by a system-on-chip (SOC) where various functions are integrated or by an image processing board on which individual elements are mounted to independently perform each process.

The display displays an image thereon based on a broadcasting signal processed by the signal processor 12. The display 13 may be achieved by various types including a plasma display panel (PDP), a liquid crystal display (LCD), an organic light emitting diode (OLED) and a flexible display, but not limited thereto.

The user input unit 14 receives a user input to control at least one of functions of the display apparatus 10. According to an embodiment of the disclosure, the user input unit 14 receives a user input with respect to a menu item relating to a plurality of setting operations displayed by the display 13.

The user input unit 14 may be achieved by a remote controller that communicates with the display apparatus 10 an infrared manner and includes a plurality of buttons. In addition, the user input unit 14 may be achieved by a keyboard or a mouse that is connected to the display apparatus 10 or by a touch screen provided in the display apparatus 10 or by an input panel provided in an external part of the display apparatus 10.

The storage unit 16 stores therein a result of a performance of at least one first setting operation and at least one second setting operation relating to a selection of a channel out of a plurality of setting operations of the display apparatus 10. For example, the storage unit 16 stores therein a performance result of a language setting, a network setting, a region setting and a time setting which are set by a user input out of a plurality of setting operations when the display apparatus 10 is initially set. By doing so, the display apparatus 10 operates by using the result stored therein without a need to perform the initial setting again when the display apparatus 10 is turned on again after being turned off.

As another example, the storage unit 16 stores therein a performing result of an automatic channel setting or a channel setting by a user input out of a plurality of setting operations when the display apparatus 10 is initially set. By doing so, the display apparatus 10 may receive a broadcasting signal per channel by using the stored result of the channel setting without a need to perform the channel setting again when the display apparatus 10 is turned on again after being turned off.

The controller 15 is achieved by at least one processor controlling an execution of a program command for all elements of the display apparatus 10 to operate. The at least one processor may be achieved by a central processing unit (CPU) and includes three sections of control, calculation and register. The control section interprets a program command, and instructs each element of the display apparatus 10 regarding their operations according to a meaning of the interpreted command. The calculation section performs an arithmetic operation and a logical operation and performs operations needed for each element of the display apparatus 10 according to an instruction of the control section. The register is a memory location storing therein necessary information while a CPU executes a command, and stores therein commands and data for elements of the display apparatus 10 and a calculated result.

The controller 15 performs at least one first setting operation based on a user input that is input through the user input unit 14. The first setting operation may include at least one of a language setting, network setting, consent to terms and conditions, region setting, time setting, device connection and registration of an account for an initial setting of the display apparatus 10. The first setting operation is not limited to a plurality of setting operations that are set when the display apparatus 10 is initially set, and may include all of a plurality of setting operations needed when the display apparatus 10 plays a broadcasting or performs other various functions.

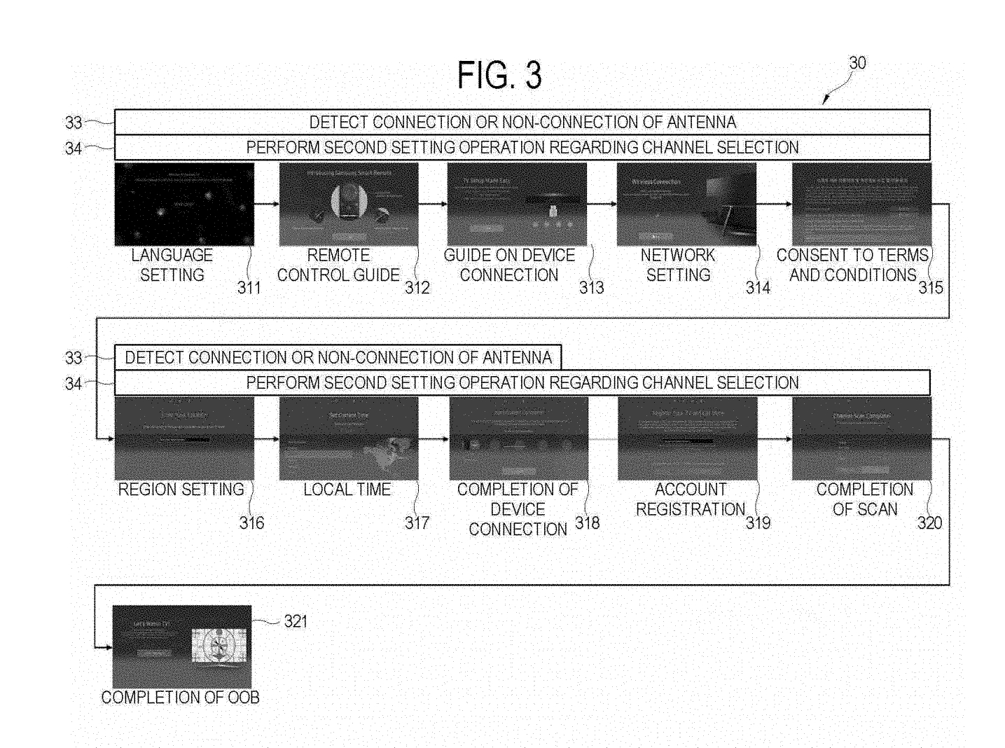

According to an embodiment, the controller 15 may control the display 13 to display thereon a plurality of menu items regarding a plurality of setting operations and may perform at least one first setting operation based on a user input with respect to the plurality of menu items. For example, as shown in FIG. 3, when a TV 30 is initially set, menu items of a plurality of setting operations such as a language setting 311, a remote control guide 312, . . . and an account registration 319 are sequentially displayed and the setting operation is performed according to a user input with respect to the respective menu items.

The controller 15 processes at least one second setting operation relating to a selection of a channel for a broadcasting signal through the signal receiver 11 in parallel with the performance of the first setting operation. The second setting operation includes an operation of selecting a channel by searching a frequency of a broadcasting signal transmitted by at least one broadcasting transmitting apparatus 19 such as a terrestrial wave, cable and satellite.

The controller 15 may perform a second setting operation based on at least one of a connection or non-connection of an antenna and a signal strength of a broadcasting signal per channel. According to an embodiment, the controller 15 may perform a second setting operation when it is detected that an antenna is connected to the TV 30. As an example, as shown in FIG. 3, when the TV 30 is initially set, it is detected (33) whether an antenna is connected thereto while the controller 15 performs a first setting operation such as the language setting 311, the remote control guide 312, . . . and the account registration 319 according to a user input. If it is detected that the antenna is connected to the TV 30, the controller 15 controls to perform (34) the second setting operation regarding a selection of a channel while the first setting operation is performed.

As above, if it is detected that an antenna is connected to the TV 30 while the first setting operation is performed based on a user input, the controller 15 controls to perform the second setting operation for selecting a channel in parallel with the performance of the first setting operation to thereby reduce the channel setting time.

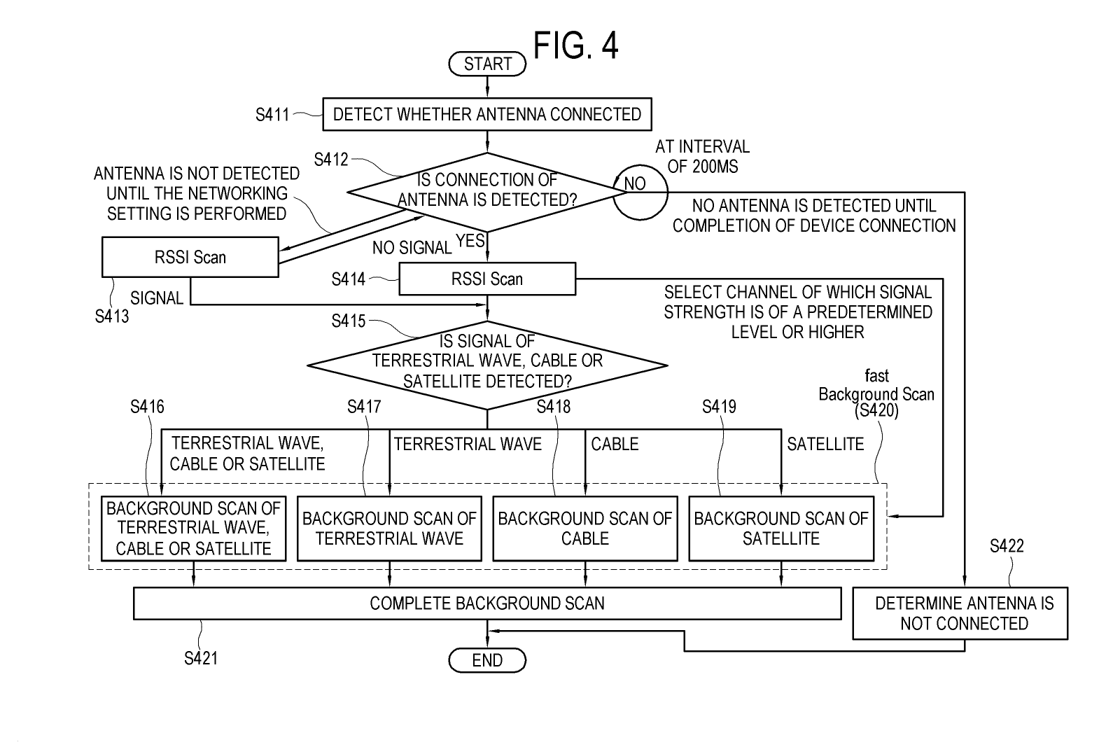

According to an embodiment, the controller 15 may scan a broadcasting signal per channel, select a channel of which a scanned broadcasting signal has a strength of a predetermined level or higher, and perform the second setting operation with respect to the selected channel. As an example, as shown in FIG. 4, it is detected whether an antenna is connected to the TV 30 at operation S412. If it is detected that the antenna is connected thereto, a received signal strength indicator (RSSI) scan is performed at operation S414. In such case, a broadcasting signal received through the RSSI scan may be scanned at a high speed to determine whether the signal is at a particular level or higher. At operation S415, it is determined through the RSSI scan whether terrestrial, cable and satellite signals are detected, and according to a result of the determination, a background scan operation is performed with respect to a channel of which a signal is detected.

As above, in the display apparatus 10, the second setting operation for selecting the channel, of which the broadcasting signal at a predetermined level or higher is detected, is performed in parallel with the performance of the first setting operation based on the user input and thus the time for setting channels may be reduced.

The controller 15 may perform the second setting operation based on a user input that is input through the user input unit 14. The second setting operation may include an operation of selecting at least one broadcasting transmitting apparatus 19 based on a user input for selecting a channel of a broadcasting signal. As an example, if the connection of the antenna is not detected or a signal is not detected through the RSSI scan while the first setting operation is performed, a user may select a terrestrial, cable or satellite mode on his/her own and set channels.

As above, the display apparatus 10 according to an embodiment of the disclosure may reduce the time for setting channels. Also, the display apparatus 10 may minimize the setting of channels by a user.

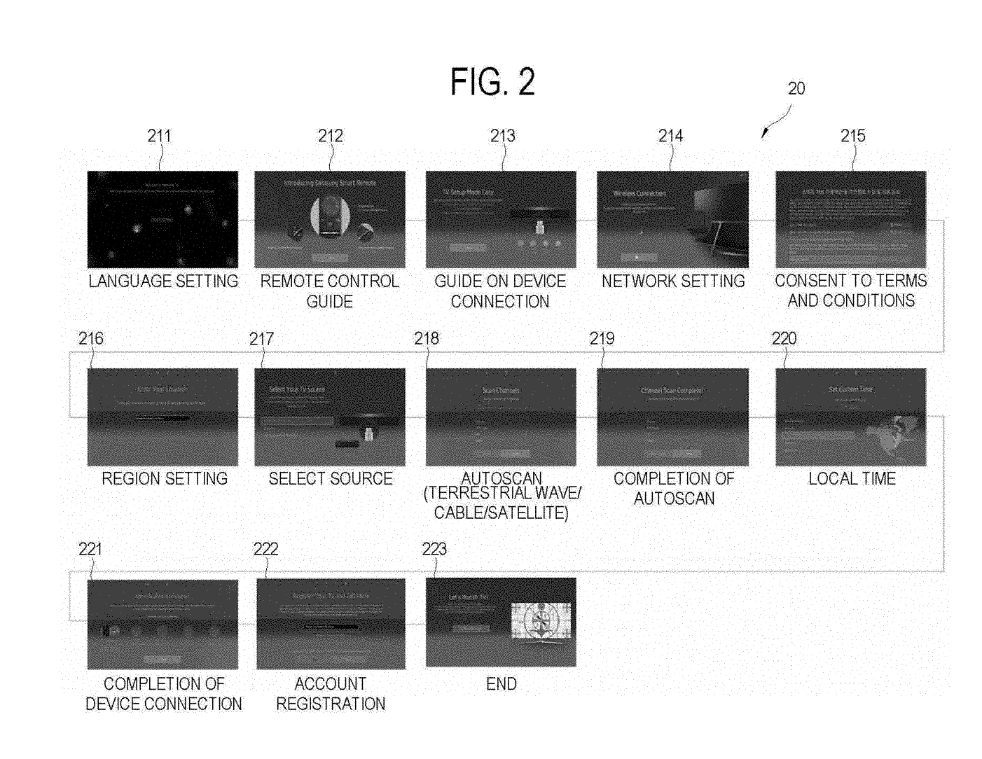

FIG. 2 illustrates an example of performing a plurality of setting operations for an initial setting by a related art of the disclosure. As shown therein, in a case of the related art of the disclosure, menu items regarding a plurality of setting operations such as the language setting 211, the remote control guide 212, . . . and the account registration 222 in a TV 20 are sequentially displayed, and the setting operation is performed according to a user input to the menu items, and the initial setting phase (GOB) is completed (223).

Setting a channel at the initial setting phase is performed at phases of selecting a source 217, of automatically scanning of each of a terrestrial wave, cable and satellite 218 and of completing automatic scan 219 after the region setting 216 is completed. The channel setting is performed according to a user input, and after all of the channel setting is completed, the initial setting phase is continuously performed.

At the phase of selecting the source 217, a user selects a source for which he/she desires to scan a channel out of a terrestrial wave, cable and satellite. Then, at the phase of automatic scan of the terrestrial wave, cable and satellite 218, the automatic channel scan is performed with respect to a broadcasting signal transmitted by the source selected by a user.

If the channel scan of the selected source is completed at the phase of completing the auto scan 219, a user may move to the phase of selecting a source 217 so that he/she can scan a channel for another source. If a user does not desire to scan a channel for another source, he/she can end the channel setting phase and move to the next initial setting phase.

According to an embodiment, at the phase of automatic scan 218 of a terrestrial wave, cable and satellite, a user may perform the channel scan after setting an input broadcasting method, RF, bandwidth, Symbolrate, QAM, color system and sound system on his/her own with respect to the source selected out of the terrestrial wave, cable and satellite. In such case, a user may feel inconvenient during the channel setting process since he/she is not familiar with such channel setting information.

In addition, when channels are set in a related art of the disclosure, even if an automatic scan is performed without directly setting information by a user regarding a source selected by him/her, a user should confirm all of the channel scan process for each of the terrestrial wave, cable and satellite and thus it takes a long time for setting channels.

FIG. 3 illustrates an example of performing a second setting operation for selecting a channel in parallel with an operation of at least one first setting operation for an initial setting according to an embodiment of the disclosure. As shown therein, when the TV 30 is initially set, menu items of at least one first setting operation such as a language setting 311, a remote control guide 312, . . . and an account registration 319 are sequentially displayed and a setting operation is performed according to a user input for the respective menu items.

According to an embodiment, while the first setting operation such as the language setting 311, the remote control guide 312, and account registration 319 is performed according to a user input at the initial setting, it is detected whether an antenna is connected to the TV 30(33). If it is detected that the antenna is connected thereto, a second setting operation for selecting a channel is performed in parallel with the performance of the first setting operation. The second setting operation for channel selection includes a channel scan operation for a broadcasting signal transmitted by at least one of sources such as a terrestrial wave, cable and satellite.

According to an embodiment, when at least one first setting operation begins for initial setting, if a terrestrial antenna is connected to the TV 30, a second setting operation may be performed with respect to a broadcasting signal transmitted by a terrestrial wave. Thereafter, while the first setting operation is performed, if a cable antenna other than the terrestrial antenna is connected to the TV 30, the display apparatus 10 may perform the second setting operation with respect to a broadcasting signal transmitted by the cable by detecting the newly connected antenna. As above, while the first setting operation is performed for initial setting, the connection of the new antenna can be detected and the second setting operation may be performed with respect to the broadcasting signal transmitted by the new antenna.

According to an embodiment, in detecting whether the antenna is connected to the TV 30 while at least one first setting operation is performed according to a user input at the initial setting (33), if a tuner jack is broken, it may be erroneously detected that the antenna is not connected. In consideration of the foregoing case, if the connection of the antenna is not detected until the networking setting phase 314 at the initial setting, the RSSI scan may be performed. By the RSSI scan, a broadcasting signal transmitted to the display apparatus 10 may be scanned at a high speed to thereby determine whether a signal at a predetermined level is recognized. Accordingly, while the first setting operation is performed, the second setting operation for channel selection may be performed (34) with respect to the channel of which the signal at the predetermined level or higher is detected by the RSSI scan.

According to an embodiment, in detecting whether the antenna is connected to the display apparatus 10 while at least one first setting operation is performed according to a user input at the initial setting (33), if no antenna is detected until the phase of completion of device connection 318, the antenna may be determined to have not been connected and the operation of detecting the connection of the antenna 33 may be ended.

According to another embodiment, if the connection of an antenna is not detected until the phase of completion of device connection 318 while at least one first setting operation is performed according to a user input at the initial setting, at last one second setting operation may be performed according to a user input. As an example, if the connection of an antenna is not detected until the phase of completion of device connection 318, a menu item may be displayed on a screen for a user to directly select a source for channel scan and to scan channels for the broadcasting signal transmitted by the source selected by a user input.

As described, according to the embodiments of the disclosure, while the at least one first setting operation is performed for the initial setting, the second setting operation relating to the channel selection is performed in parallel with the first setting operation, and thus there is an effect of preventing any additional time from being taken for channel setting. Also, a user setting is minimized in performing the second setting operation and thus a user's convenience may be improved.

FIG. 4 is a flowchart showing a process for performing a second setting operation according to an embodiment of the disclosure. As shown therein, the process of performing the second setting operation that is in parallel with the performance of at least one first setting operation at the initial setting phase of the display apparatus 10 will be described.

At operation S411, a connection of an antenna is detected, and at operation S412, it is detected whether the connection of the antenna is detected. If it is determined that the antenna is connected to the display apparatus 10, the RSSI scan is performed at operation S414. The operation S414 includes an operation of scanning a broadcasting signal transmitted to the display apparatus 10 per channel and of recognizing a channel of which the scanned broadcasting signal has a signal strength of a predetermined level or higher.

At operation S415, it is determined whether at least one signal of a terrestrial wave, cable and satellite is detected according to a result of the RSSI scan. If it is determined that signals of all of the terrestrial wave, cable and satellite are detected, a background scan operation is performed with respect to broadcasting signals transmitted by the terrestrial wave, cable and satellite corresponding to the second setting operation at operation S416. The background scan operation is performed to process a broadcasting signal by at least one processor in parallel with the first setting operation rather than displaying a corresponding menu item on the display 13 like the at lest one setting operation for initial setting.

If a terrestrial signal is detected out of terrestrial, cable and satellite signals at operation S415, the background scan operation is performed with respect to a broadcasting signal transmitted by the terrestrial wave at operation S417. Likewise, if a cable signal is detected at operation S415, the background scan operation is performed with respect to a broadcasting signal transmitted by the cable at operation S418. If a satellite signal is detected, the background scan operation is performed with respect to a broadcasting signal transmitted by the satellite at operation S419.

Lastly, at operation S412, the background scan operation is completed with respect to the signal detected out of the terrestrial wave, cable and satellite.

According to an embodiment, even if the connection of the antenna is not detected until the phase of network setting 318, the RSSI scan is performed at operation S413. If a signal with a predetermined signal level or higher is detected according to a result of the RSSI scan, it is determined whether at least one signal from the terrestrial wave, cable and satellite is detected at operation S415. At operations S416 to S419, the corresponding background scan operation is performed.

According to an embodiment, if the connection of the antenna is not detected at operation S412, the operation S412 is repeatedly performed at an interval of, e.g. 200 ms. If the connection of the antenna is not detected until the phase of completion of device connection 318, the antenna is determined to be unconnected and the performance of the second setting operation is ended at operation S422.

According to an example, if a channel with a signal strength being a predetermined level or higher is selected according to the result of the RSSI scan at operation S414, a fast background scan operation is performed with respect to the selected channel. That is, the background scan operation is performed with respect to the channel of which the signal strength is a predetermined level of higher rather than with respect to all channels of which signals are detected and thus the channel setting can be completed within a shorter time.

According to the embodiment of the disclosure as above, while the at least one first setting operation is performed for initial setting, the channel setting is processed with respect to the broadcasting signal transmitted by at least one of the terrestrial wave, cable and satellite in parallel with the first setting operation so that the channel setting time can be reduced.

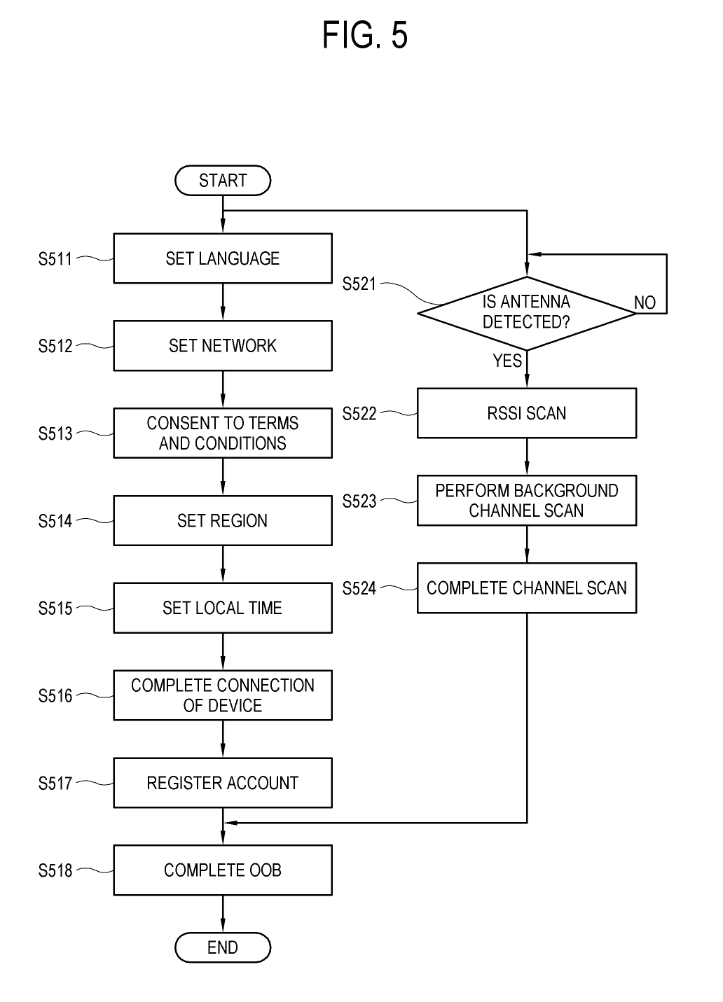

FIG. 5 is a flowchart showing processes for performing first and second setting operations according to an embodiment of the disclosure. As shown therein, the process for performing at least one first and second setting operations in parallel at the initial setting phase of the display apparatus 10 will be described. The first setting operation corresponds to operations S511 to S517, and the second setting operation corresponds to operations S521 to S524. The first and second setting operations are performed in parallel, and if all of the first and second setting operations are completed, the initial setting phase (GOB) is completed at operation S518.

The first setting operation is performed based on a user input, and the second setting operation is performed by a background method without a user input. According to an embodiment, a partial setting for the second setting operation may be performed by a user input. For example, the operation of selecting at least one source of a terrestrial wave, cable and satellite is performed according to a user input and the operation of scanning channels for a broadcasting signal transmitted by the selected source can be automatically performed without a user input.

Regarding the first setting operation, the language setting of the initial setting phase is performed and a basic language to be used by the display apparatus 10 is set at operation S511. At operation S512, the network setting is performed and a network is set for communicating by a wired communication method such as Ethernet or by a wireless communication method such as Wi-Fi or Bluetooth.

At operation S513, a process for obtaining a user's consent to the terms and conditions for usage of the display apparatus 10 is performed. At operation S514, information regarding the country and region where the display apparatus 10 is used is set. At operation S515, the local time is set. At operation S516, the connection of the device to the display apparatus 10 is completed. At operation S517, a setting for registering a user's account to be managed to provide customized service to a user of the display apparatus 10 is performed.

While the at least one first setting operation is performed corresponding to the operations S511 to S517 as above, the second setting operation is performed in parallel therewith.

Regarding the second setting operation, at operation S521, it is detected whether the antenna is connected. If it is detected that the antenna is connected, the RSSI scan is performed and the channel of which the broadcasting signal is of a high level or higher is detected at operation S522.

At operation S523, the background channel scan is performed with respect to the channel of which the signal strength is of a predetermined level of higher as detected by the RSSI scan. At operation S524, the channel scan operation is completed.

According to an embodiment, while the first setting operation corresponding to the operations S511 to S517 is performed, if all of the second setting operation corresponding to the operations S521 to S524 is completed, the initial setting phase (OOB) of the display apparatus 10 is completed at operation S518.

According to another embodiment, while the first setting operations corresponding to the operations S511 to S517 is performed, if at least one of the operations S521 to S524 corresponding to the second setting operations is incomplete, the incomplete second setting operation is performed after the first setting operation is completed to thereby complete the initial setting phase (OOB) of the display apparatus 10 at operation S518.

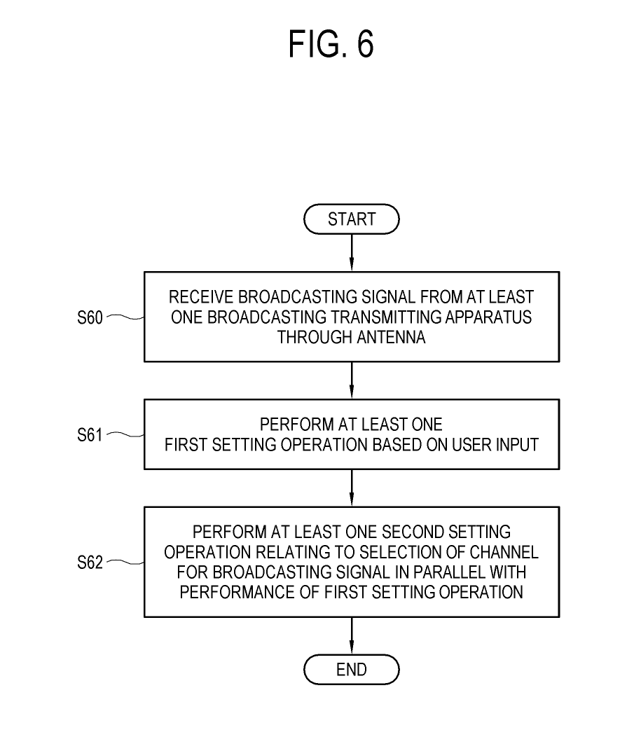

FIG. 6 is a flowchart showing a control method of the display apparatus 10 according to an embodiment of the disclosure. As shown therein, at operation S60, a broadcasting signal is transmitted by at least one broadcasting transmitting apparatus 19 through an antenna. The broadcasting transmitting apparatus 19 includes an apparatus transmitting broadcasting signals from a terrestrial, cable or satellite broadcasting station.

At operation S61, at lest one first setting operation is performed based on a user input. The first setting operation includes at least one of the language setting, network setting, consent to terms and conditions, region setting, time setting, device connection and account registration for initial setting of the display apparatus 10.

At operation S62, at least one second setting operation relating to channel selection for a broadcasting signal is performed in parallel with the performance of the first setting operation. The second setting operation includes an operation for selecting a channel by searching a frequency of the broadcasting signal transmitted by at least one broadcasting transmitting apparatus 19 such as terrestrial, cable and satellite.

According to an embodiment, the operation S62 may include an operation of performing the second setting operation based on a user input. The second setting operation may include an operation of selecting at least one broadcasting transmitting apparatus based on a user input to select the channel of the broadcasting signal.

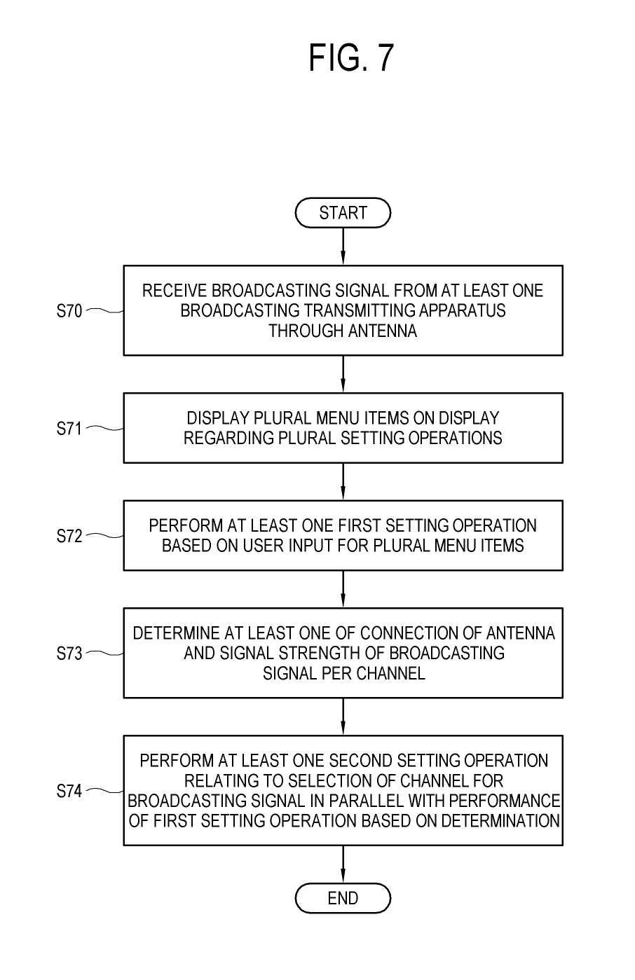

FIG. 7 is a flowchart showing a control method of the display apparatus 10 according to an embodiment of the disclosure. As shown therein, at operation S70, a broadcasting signal is transmitted by at least one broadcasting transmitting apparatus 19 through an antenna. At operation S71, a plurality of menu items regarding the plurality of setting operations is displayed by the display 13.

At operation S72, at least one first setting operation is performed based on a user input for the plurality of menu items. The first setting operation includes at least one of the language setting, network setting, consent to terms and conditions, region setting, time setting, device connection and account registration for the initial setting of the display apparatus 10. That is, in the case of the first setting operation, the menu item is displayed corresponding to a screen, and the setting operation is performed according to a user input.

At operation S73, at least of the connection of the antenna and the signal strength of the broadcasting signal per channel is determined. Lastly, at operation S74, at least one second setting operation is performed in connection with the selection of the channel for the broadcasting in parallel with the performance of the first setting operation based on the determination made at operation S73.

According to an embodiment, the operation S74 may include an operation of performing the second setting operation in parallel with the performance of the first setting operation if it is detected that the antenna is connected. Accordingly, if it is detected during the initial setting of the TV that the antenna is connected to the TV, the channel setting may be automatically performed.

According to an embodiment, the operation S74 may include an operation of scanning the transmitted broadcasting signal per channel, of selecting the channel of which the signal strength of the scanned broadcasting signal is a predetermined level or higher, and of performing the second setting operation with respect to the selected channel. As the channel setting is performed only with respect to the channel of which the signal strength of the broadcasting signal is of the predetermined level of higher while the TV is initially set, thereby reducing the channel setting time.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

1. A display apparatus comprising:
a signal receiver for receiving a broadcasting signal from at least one broadcasting transmitting apparatus through an antenna;
a display for displaying an image thereon based on the transmitted broadcasting signal;
a user input unit for receiving a user input; and
a controller for performing at least one setting operation based on the user input, and for performing at least one second setting operation relating to a selection of a channel for the broadcasting signal through the signal receiver in parallel with the performance of the first setting operation.

2. The display apparatus according to claim 1, wherein the controller performs the second setting operation based on at least one of a connection or non-connection of the antenna and a signal strength of the broadcasting signal per channel.

3. The display apparatus according to claim 1, wherein the controller performs the second setting operation if it is detected that the antenna is connected.

4. The display apparatus according to claim 1, wherein the controller scans the transmitted broadcasting signal per channel, selects a channel of which the signal strength of the scanned broadcasting signal is of a predetermined level or higher, and performs the second setting operation with respect to the selected channel.

5. The display apparatus according to claim 1, further comprising a user input unit for receiving a user input, wherein the controller performs the second setting operation based on the user input.

6. The display apparatus according to claim 5, wherein the second setting operation comprises an operation of selecting one of the at least one broadcasting transmitting apparatus based on the user input to select a channel for the broadcasting signal.

7. The display apparatus according to claim 1, wherein the first setting operation comprises at least one of a language setting, network setting, consent to terms and conditions, region setting, time setting, device connection and account registration for an initial setting of the display apparatus.

8. The display apparatus according to claim 1, wherein the controller displays a plurality of menu items on the display regarding a plurality of setting operations, and performs the at least one first setting operation based on a user input regarding the plurality of menu items.

9. A control method of a display apparatus comprising:
receiving a broadcasting signal from at least one broadcasting transmitting apparatus through an antenna;
performing at least one first setting operation based on a user input; and
performing at least one second setting operation relating to a selection of a channel for the broadcasting signal in parallel with the performance of the first setting operation.

10. The control method according to claim 9, wherein the processing the second setting operation in parallel comprises performing the second setting operation based on whether the antenna is connected and a signal strength of the broadcasting signal per channel.

11. The control method according to claim 9, wherein the performing the second setting operation in parallel comprises performing the second setting operation if it is detected that the antenna is connected.

12. The control method according to claim 9, wherein the processing the second setting operation in parallel comprises scanning the transmitted broadcasting signal per channel, selecting a channel of which a signal strength of the scanned broadcasting signal is of a predetermined level of higher, and performing the second setting operation with respect to the selected channel.

13. The control method according to claim 9, wherein the performing the second setting operation in parallel comprises performing the second setting operation based on a user input.

14. The control method according to claim 13, wherein the second setting operation comprises an operation of selecting one of the at least one broadcasting transmitting apparatus based on the user input to select the channel for the broadcasting signal.

15. The control method according to claim 9, wherein the first setting operation comprises at least one of a language setting, a network setting, a consent to terms and conditions, a region setting, a time setting, a device connection and an account registration for initially setting the display apparatus.
